(19) United States
(12) Patent Application Publication
(10) Pub. No.: US 2016/0112751 A1
(43) Pub. Date: Apr. 21, 2016

(54) METHOD AND SYSTEM FOR DYNAMIC DISCOVERY OF RELATED MEDIA ASSETS

(71) Applicant: THOMSON LICENSING, Issy-les-Moulineaux (FR)

(72) Inventor: Bastien MINNITI, Burbank, CA (US)

(73) Assignee: THOMSON LICENSING, Issy-les-Moulineaux (FR)

(21) Appl. No.: 14/893,580

(22) PCT Filed: Aug. 2, 2013
(86) PCT No.: PCT/US13/53409

§ 371 Date: Nov. 24, 2015

Related U.S. Application Data
(60) Provisional application No. 61/828,382, filed on May 29, 2013.

(51) Int. Cl. H04N 21/431; H04N 21/45; H04N 21/84; H04N 21/482; H04N 21/4725

(52) U.S. Cl. CPC H04N 21/4312; H04N 21/4826; H04N 21/4725; H04N 21/84; H04N 21/4532

(57) ABSTRACT

A method and system for dynamic discovery of related media assets is provided. The method includes providing a plurality of media asset representations for a plurality of media assets to be displayed to a user on a display screen. The method further includes receiving an indication of a selection of a media asset from among the plurality of media assets. The selection is made by the user moving the selected media asset to a pre-designated location on the display screen. The method also includes providing recommendations of related media assets responsive to the indication. The recommendations are provided in other locations on the display screen. Each of the other locations is associated with a respective one of a plurality of media related categories.

### CROSS-REFERENCE TO RELATED APPLICATIONS

This application claims the benefit of U.S. Provisional Application Ser. No. 61/828,382 (Attorney Docket No. PU130062), filed May 29, 2013, which is incorporated by reference herein in its entirety.

### TECHNICAL FIELD

The present principles relate generally to user interfaces and, more particularly, to a method and system for dynamic discovery of related media assets.

### BACKGROUND

Currently, user interfaces from digital content providers (such as, for example, but not limited to, Netflix™, Hulu™, and Amazon™) do not provide the ability for a user to customize the layout of related media asset selections. Such digital content providers include, but are not limited to, third party digital content providers that provide content to an end user via an Internet provider such as the aforementioned companies.

### SUMMARY

These and other drawbacks and disadvantages of the prior art are addressed by the present principles, which are directed to a method and system for dynamic discovery of related media assets.

According to an aspect of the present principles, there is provided a method. The method includes providing a plurality of media asset representations for a plurality of media assets to be displayed to a user on a display screen. The method further includes receiving an indication of a selection of a media asset from among the plurality of media assets. The selection is made by the user moving the selected media asset to a pre-designated location on the display screen. The method also includes providing recommendations of related media assets responsive to the indication. The recommendations are provided in other locations on the display screen. Each of the other locations is associated with a respective one of a plurality of media related categories.

According to another aspect of the present principles, there is provided a system. The system includes a media description database for providing a plurality of media asset representations for a plurality of media assets to be displayed to a user on a display screen. The system further includes a related media asset searcher for receiving an indication of a selection of a media asset from among the plurality of media assets and providing recommendations of related media assets responsive to the indication. The selection is made by the user moving the selected media asset to a pre-designated location on the display screen. The recommendations are provided in other locations on the display screen. Each of the other locations is associated with a respective one of a plurality of media related categories.

According to yet another aspect of the present principles, there is provided a non-transitory computer readable storage medium having computer executable code stored thereon for performing a method. The method includes providing a plurality of media asset representations for a plurality of media assets to be displayed to a user on a display screen. The method further includes receiving an indication of a selection of a media asset from among the plurality of media assets. The selection is made by the user moving the selected media asset to a pre-designated location on the display screen. The method also includes providing recommendations of related media assets responsive to the indication. The recommendations are provided in other locations on the display screen. Each of the other locations is associated with a respective one of a plurality of media related categories.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for dynamic discovery of related media assets, in accordance with an embodiment of the present principles;

FIG. 4 shows an exemplary method 400 for dynamic discovery of related media assets, in accordance with an embodiment of the present principles;

FIG. 5 shows an exemplary user interface 500 for displaying related media assets, in accordance with an embodiment of the present principles;

FIG. 6 shows an exemplary representation 600 of a media asset being moved to the center of the user interface 500 of FIG. 5, in accordance with an embodiment of the present principles; and

FIG. 7 shows an exemplary representation 700 of the results of related media assets with respect to the selected media asset of FIG. 6, in accordance with an embodiment of the present principles.

### DETAILED DESCRIPTION

The present principles are directed to a method and system for dynamic discovery of related media assets.

In an embodiment, a user interface is provided that displays media asset recommendations that are grouped in different areas of a display screen. In an embodiment, when a first media asset is selected, a number of media asset recommendations are presented in such areas, where each area is associated with a particular topic (director, actor, genre, decade of a media asset, and the like). The subject matter of such areas can be modified in accordance with user preferences. In an embodiment, the user preferences can relate to designating an area of a specific category where media assets of that category are displayed, the topics for which related media assets will be found, and so forth.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

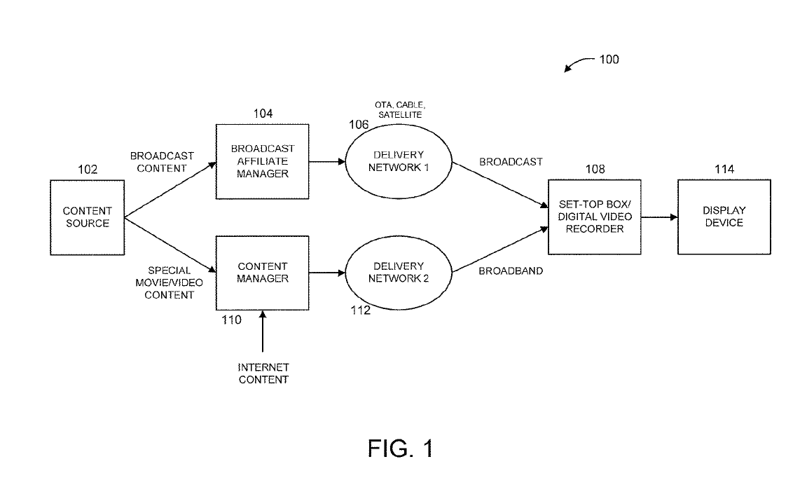

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

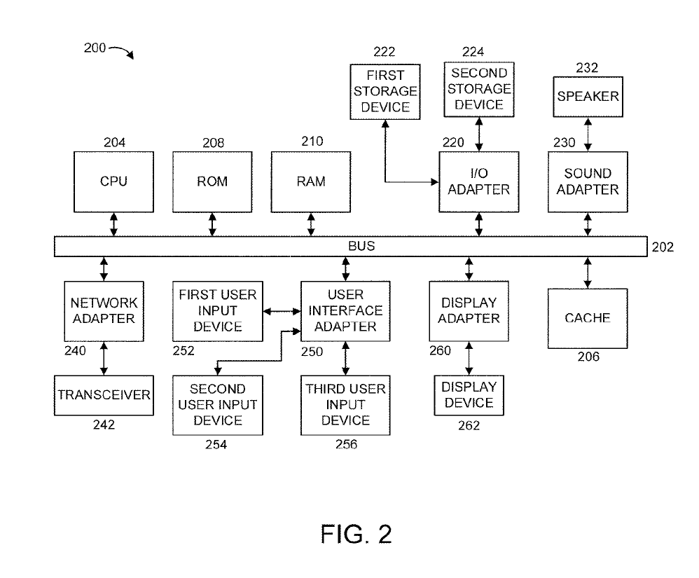

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

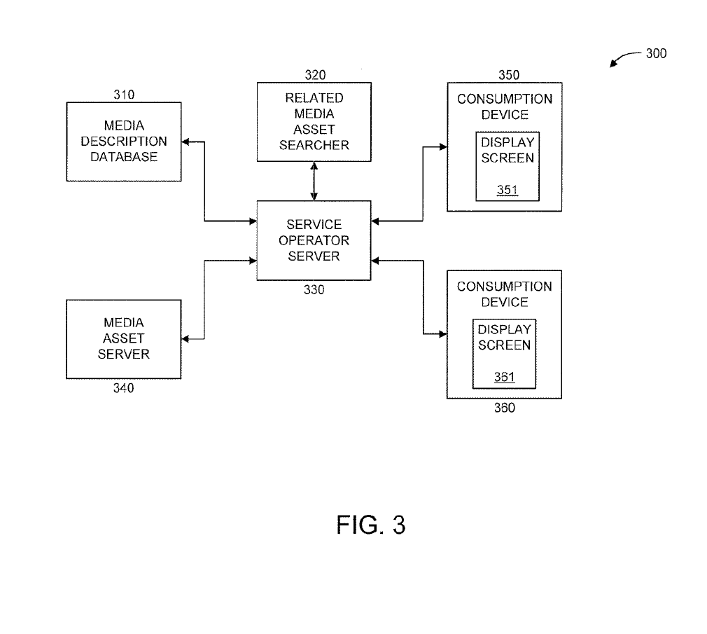

Moreover, it is to be appreciated that system 300 described below with respect to FIG. 3 is a system for implementing respective embodiments of the present principles. Part or all of processing system 200 may be implemented in one or more of the elements of system 300.

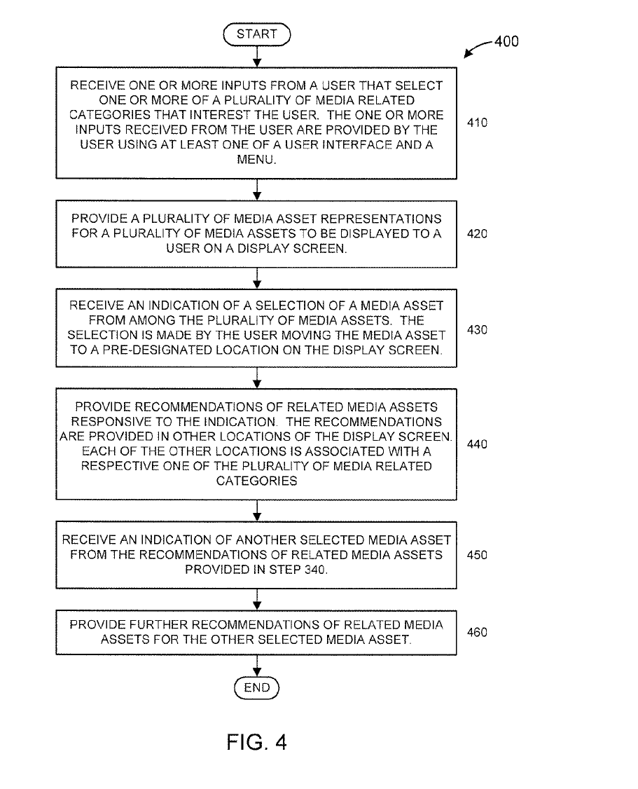

Further, it is to be appreciated that processing system 200 may perform at least part of the method described herein including, for example, at least part of method 400 of FIG. 4. Similarly, part or all of system 300 may be used to perform at least part of method 400 of FIG. 4.

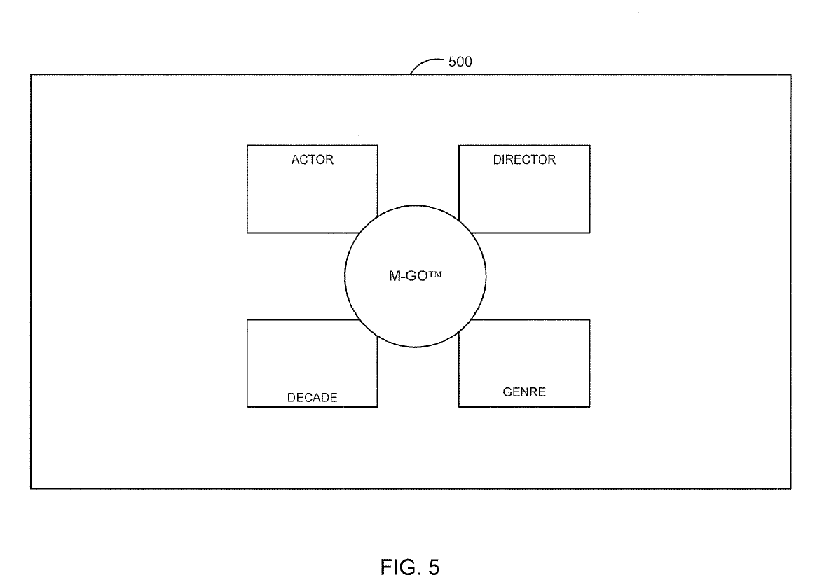

FIG. 3 shows an exemplary system 300 for dynamic discovery of related media assets, in accordance with an embodiment of the present principles. The system 300 can be used to implement the user interface 500 shown in FIGS. 5-7. The system 300 includes a media description database 310, a related media asset searcher 320, a service operator server 330, a media asset server 340, a consumption device 350, and another consumption device 360. Of course, it is be appreciated that while only two consumption devices are shown in the embodiment of FIG. 3, a different number of consumption devices can be used, while maintaining the spirit of the present principles. The consumption device 350 includes a display screen 351, and the consumption device 360 includes a display screen 361. The consumption devices 350 and 360 can be any type of media consumption and/or media presentation device.

In an embodiment, the user interface 500 can be received from any of the media asset server 340, the related media asset searcher 320, and the service operator server 330. In an embodiment, the user interface 500 is provided on the consumption devices 350 and 360 for use by a corresponding user thereof.

When the user interface 500 is presented to a user, the user can be shown a number of different media asset representations, where such representations can come from the media description database 310. In an embodiment, the media description database 310 includes both graphics and metadata corresponding to media assets. When a user places a media asset representation in the center of the user interface 500 (as shown in FIG. 5, for example), the related media asset searcher 320 can be used to search for related media assets in the media description database 310.

For example, the related media asset searcher 320 determines the metadata and metadata fields (actor, director, genre, year of copyright, and so forth) associated with the selected media asset and utilizes the metadata and metadata fields as the basis of a search. The metadata fields that are searched are determined in view of the media related categories a user has selected as shown in FIGS. 5-7. Alternatively, such metadata fields are preselected for a user and can be subsequently changed by a user based on the user's preferences. A user profile, based on prior selections/consumption of media assets can be used for determining which related media assets should be shown.

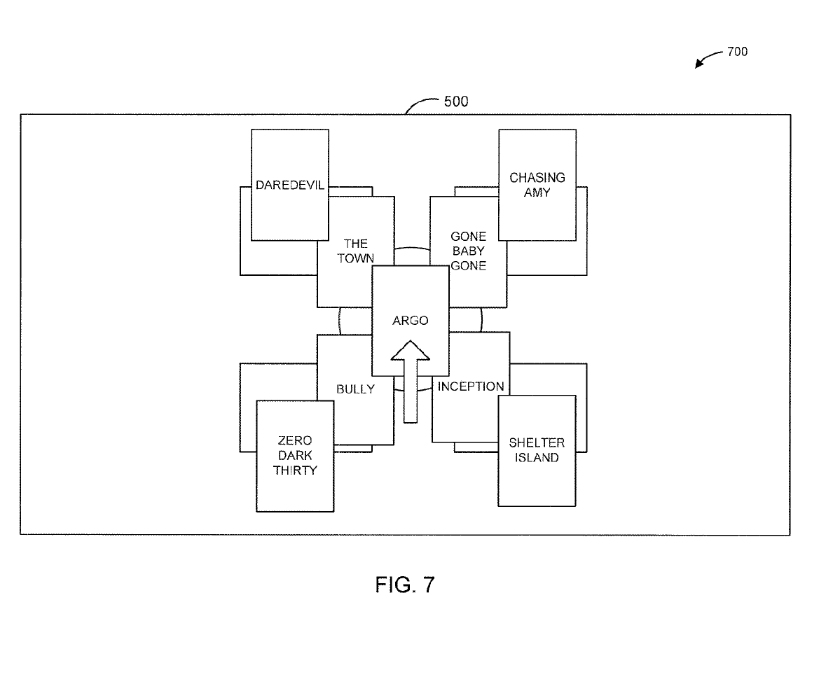

After conducting the search for related media assets, the results can be displayed as shown in FIG. 7, where such results can be filtered in view of user profile information. A selected media asset can then be played back from the media asset server 340 through the server provider server 330 when a user is using an over-the-top service, a service provider, a video on demand service, and so forth. It is to be appreciated that the preceding listing is merely illustrative and, thus, other types of services and providers can also be used in accordance with the teachings of the present principles, while maintaining the spirit of the present principles.

FIG. 4 shows an exemplary method 400 for dynamic discovery of related media assets, in accordance with an embodiment of the present principles.

At step 410, receive one or more inputs from a user that select one or more of a plurality of media related categories that interest the user. The one or more inputs received from the user are provided by the user using at least one of a user interface (e.g., user interface 500) and a menu. In another embodiment, these categories can be pre-selected (e.g., as default categories), and the user can then modify the selections in step 410 if the user so chooses.

At step 420, provide a plurality of media asset representations for a plurality of media assets to be displayed to a user on a display screen.

At step 430, receive an indication of a selection of a media asset from among the plurality of media assets. The selection is made by the user moving the media asset to a pre-designated location on the display screen.

At step 440, provide recommendations of related media assets responsive to the indication. The recommendations are provided in other locations on the display screen. Each of the other locations is associated with a respective one of the plurality of media related categories.

At step 450, receive an indication of another selected media asset from among the recommendations of related media assets provided in step 440.

At step 460, provide further recommendations of the related media assets for the other selected media asset.

The present principles provide a user interface (e.g., user interface 500) where a person places a representation of a media asset into a central area. The user interface then renders different representations of related media assets in various areas of the user interface area. The areas are representations of different categories such as actor, director, decade, genre, producer, studio, and the like which can be selected by a user via a menu, user interface, or other means. It is to be appreciated that the preceding categories are merely illustrative and, thus, other categories can also be used, while maintaining the spirit of the present principles.

FIG. 5 shows an exemplary user interface 500 for displaying related (recommended) media assets, in accordance with an embodiment of the present principles. The user interface 500 includes a central area (in this example, the central area is labeled “M-Go”™), where a user places representations of media assets. When such a placement occurs, other recommended/related media assets are shown in the other areas denoted as “actor”, “director”, “decade”, “producer” which represent different categories which can be selected by a user. It is to be appreciated that while “a central area” is used in the example of FIG. 5, another pre-designated area can be used to essentially trigger the recommendation of related media assets.

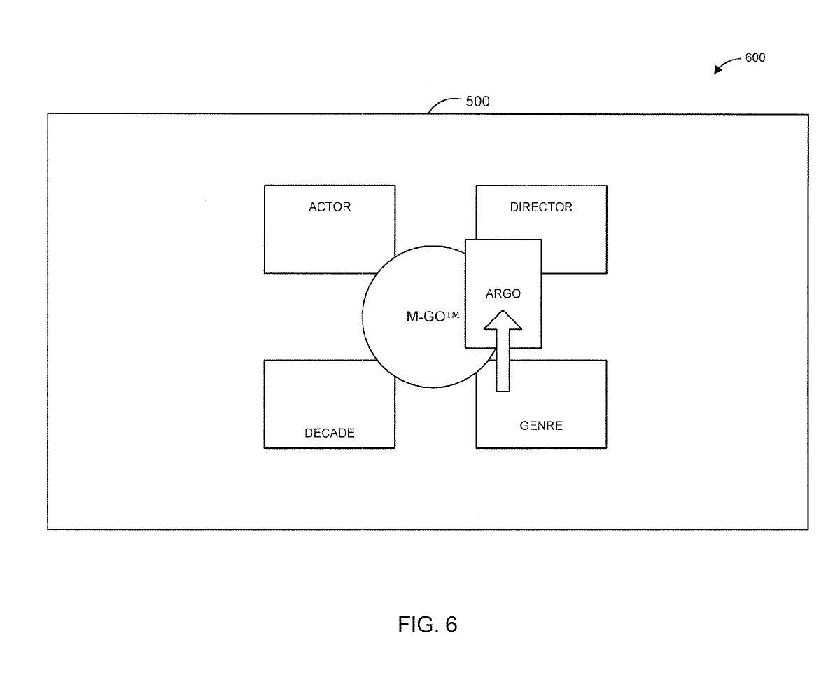

FIG. 6 shows an exemplary representation 600 of a media asset being moved to the center of the user interface 500 of FIG. 5, in accordance with an embodiment of the present principles. In the example of FIG. 6 (and FIG. 7), the media asset being moved to the center of the user interface 500 is the movie “Argo”. The action of moving the media asset “Argo” to the center of the user interface 500 (or some other pre-designated area in another embodiment(s) of the present principles) essentially results in selecting that media asset (Argo).

FIG. 7 shows an exemplary representation 700 of the results of related media assets with respect to the selected media asset (Argo) of FIG. 6, in accordance with an embodiment of the present principles. In the “actor” quadrant, movies starring Ben Affleck are shown such as “Daredevil” and “The Town” because Ben Affleck was an actor in the movie “Argo”.

Likewise, in the “director” quadrant, movies that had similar directors to “Argo” are shown in the “director” quadrant. Hence, the movie “Gone Baby Gone” which was directed by Ben Affleck is shown as a related media asset, while the movie “Chasing Amy” is shown which was directed by Kevin Smith, a director who works with Ben Affleck (who starred in “Chasing Amy”) on many projects. Thus, as is evident, the “director” quadrant can correspond to similar directors, the same director, directors who have worked with a corresponding actor in the selected media asset, and so forth.

The “decade” quadrant shows media assets from the 2010 decade (the same decade as “Argo”) such as “Zero Dark Thirty” and “Bully”.

Lastly, the quadrant denoted as “genre” displays suspense movies (the genre of the movie “Argo”) such as “Inception” and “Shutter Island”.

Advantageously, each of the media assets in the results can then also be moved to the center of the user interface 500 to continue the recommendation process (as shown and described with respect to steps 450 and 460 of FIG. 4).

Within the operation of FIGS. 6 and 7, different media assets will yield different results. Likewise, the selected categories for the quadrants can be modified based on user preference. In addition, the number of areas can be increase/decreased in accordance with user preferences, as well.

A description will now be given of some of the many attendant advantages/features of the present invention, some of which have been mentioned above. For example, one advantage/feature is a method that includes providing a plurality of media asset representations for a plurality of media assets to be displayed to a user on a display screen. The method further includes receiving an indication of a selection of a media asset from among the plurality of media assets. The selection is made by the user moving the selected media asset to a pre-designated location on the display screen. The method also includes providing recommendations of related media assets responsive to the indication. The recommendations are provided in other locations on the display screen. Each of the other locations is associated with a respective one of a plurality of media related categories.

Another advantage/feature is the method as described above, wherein the method further includes receiving an indication of another selected media asset. The other selected media asset is selected from among the recommendations of related media assets. The method also includes providing further recommendations of the related media assets for the other selected media asset.

Yet another advantage/feature is the method as described above, wherein the plurality of media related categories include at least one of an actor category, a director category, a decade category corresponding to a decade in which the selected media asset was made publically available, a producer category, a studio category, and a genre category.

Still another advantage/feature is the method as described above, wherein the pre-designated location is a center of the display screen and at least one of the other locations comprise a quadrant of the display screen.

Moreover, another advantage/feature is the method as described above, further comprising receiving one or more inputs from the user that select one or more of the plurality of media related categories. The recommendations are provided only for the selected one or more of the plurality of media related categories.

Further, another advantage/feature is the method as described above, wherein the one or more inputs from the user are provided by the user using at least one of the user interface and a menu.

Also, another advantage/feature is the method as described above, wherein the display screen is comprised in a user interface.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
providing a plurality of media asset representations for a plurality of media assets to be displayed to a user on a display screen;
receiving an indication of a selection of a media asset from among the plurality of media assets, the selection being made by the user moving the selected media asset to a pre-designated location on the display screen; and
providing recommendations of related media assets responsive to the indication, the recommendations being provided in other locations on the display screen, each of the other locations associated with a respective one of a plurality of media related categories.

2. The method of claim 1, further comprising:
receiving an indication of another selected media asset, the other selected media asset being selected from among the recommendations of related media assets; and
providing further recommendations of the related media assets for the other selected media asset.

3. The method of claim 1, wherein the plurality of media related categories include at least one of an actor category, a director category, a decade category corresponding to a decade in which the selected media asset was made publically available, a producer category, a studio category, and a genre category.

4. The method of claim 1, wherein the pre-designated location is a center of the display screen and at least one of the other locations comprise a quadrant of the display screen.

5. The method of claim 1, further comprising receiving one or more inputs from the user that select one or more of the plurality of media related categories, and wherein the recommendations are provided only for the selected one or more of the plurality of media related categories.

6. The method of claim 5, wherein the one or more inputs from the user are provided by the user using at least one of the user interface and a menu.

7. The method of claim 1, wherein the display screen is comprised in a user interface.

8. A system, comprising:
a media description database for providing a plurality of media asset representations for a plurality of media assets to be displayed to a user on a display screen;
a related media asset searcher for receiving an indication of a selection of a media asset from among the plurality of media assets and providing recommendations of related media assets responsive to the indication,
wherein the selection is made by the user moving the selected media asset to a pre-designated location on the display screen, the recommendations are provided in other locations on the display screen, and each of the other locations is associated with a respective one of a plurality of media related categories.

9. The system of claim 8, wherein the related media asset searcher receives an indication of another selected media asset, the other selected media asset being selected from among the recommendations of related media assets, and provides further recommendations of the related media assets for the other selected media asset.

10. The system of claim 8, wherein the plurality of media related categories include at least one of an actor category, a director category, a decade category corresponding to a decade in which the selected media asset was made publically available, a producer category, a studio category, and a genre category.

11. The system of claim 8, wherein the pre-designated location is a center of the display screen and at least one of the other locations comprise a quadrant of the display screen.

12. The system of claim 8, wherein the related media asset searcher receives one or more inputs from the user that select one or more of the plurality of media related categories, and wherein the recommendations are provided only for the selected one or more of the plurality of media related categories.

13. The system of claim 12, wherein the one or more inputs from the user are provided by the user using at least one of the user interface and a menu.

14. The system of claim 8, wherein the display screen is comprised in a user interface.

15. A non-transitory computer readable storage medium having computer executable code stored thereon for performing a method, the method comprising:
providing a plurality of media asset representations for a plurality of media assets to be displayed to a user on a display screen;
receiving an indication of a selection of a media asset from among the plurality of media assets, the selection being made by the user moving the selected media asset to a pre-designated location on the display screen; and
providing recommendations of related media assets responsive to the indication, the recommendations being provided in other locations on the display screen, each of the other locations associated with a respective one of a plurality of media related categories.
